(19) United States
(12) Patent Application Publication
(10) Pub. No.: US 2004/0112679 A1
(43) Pub. Date: Jun. 17, 2004

(54) System and method for lubricant flow control in a variable speed compressor package

(76) Inventor: Steven D. Centers, Daphne, AL (US)

Correspondence Address: John M. Harrington, Kilpatrick Stockton LLP, 1001 West Fourth Street, Winston-Salem, NC, 27101, US

(21) Appl. No.: 10/318,421

(22) Filed: Dec. 13, 2002

(51) Int. Cl. F16N 27/00

(52) U.S. Cl. 184/7.4

(57) ABSTRACT

A system and method for regulating lubricant flow in a variable speed compressor includes a compressor having an inlet for gas to be compressed, at least one lubricant injection line, and an outlet through which compressed gas and lubricant exit, a flow control interface comprising at least one valve for regulating the flow of lubricant through the lubricant injection line, and a control logic in communication with the compressor such that the operating speed of the compressor is communicated to the control logic and the control logic is in communication with the flow control interface such that the control logic sends a signal to the flow control interface to open or close the at least one valve depending on the predetermined optimum lubricant flow rate for the compressor based on its operational speed. This allows the flow of lubricant through the compressor to be varied in response to the operating needs of the compressor at different speeds.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates to control of lubricant flow in compressors and compressor systems. More particularly, this invention relates to a variable speed compressor package including a method and system for controlling lubricant flow to the compressor.

### BACKGROUND OF THE INVENTION

Rotary screw compressors have long been used to provide compressed air in industry. Such rotary screw compressors typically comprise two rotors mounted in a working space limited by two end walls and a barrel wall extending there between. The barrel wall takes the shape of two intersecting cylinders, each housing one of the rotors. Each is provided with helically extending lobes and grooves that are intermeshed to establish chevron shaped compression chambers. In these chambers, a gaseous fluid is displaced and compressed from an inlet channel to an outlet channel by way of the screw compressor. Each compression chamber during a filling phase communicates with the inlet, during a compression phase undergoes a continued reduction in volume, and during a discharge phase communicates with an outlet.

The oil in the compressor does several things. First, it provides lubrication to prevent the moving parts from making contact and wearing. Second, it acts as a sealing agent to fill in all of the possible leak paths through which the compressed air might escape. Thirdly, it acts as a thermal transfer medium to absorb some of the heat of compression. The oil is discharged from the compressor with the compressed air into an air-oil separator tank where the oil is removed from the air. Although there will be some oil remaining in the compressed air, it is only at a level of parts per million.

Variable speed compressors operate in much the same way as a conventional one-speed compressor. However, in a variable speed compressor, a variable speed drive is connected to the motor. The variable speed drive regulates the motor speed which, in turn, governs the speed of the compressor. However, this inventor has discovered that variable speed compressors demand lubricant differently than was commonly thought. As compressor speed increases, less oil is needed to keep the compressor operating at optimum efficiency. At lower compressor speeds, more oil is needed to maintain an efficient compressor. Therefore, an oil pump cannot be used with variable speed compressors because the oil pump pumps too much oil at high speeds and/or pumps too little oil at low speeds. This problem may be solved by removing the oil pump and operating the compressor without the pump. The package sump pressure is used to push the oil through the system. However, this method of oil regulation does not allow for controlling the oil flow independently of the sump pressure.

Prior variable speed compressors have not combined the advantages of a variable speed compressor with an oil flow control that over come the disadvantages of inefficient compressor output due to improper oil flow at various compressor speeds.

In particular, prior variable speed compressor system designs have not combined an oil flooded rotary screw compressor having the capability of controlling lubricant flow to optimize efficiency at all compressor speeds.

Thus, there is a need to provide a compressor package in which the oil flow to the compressor can be controlled to improve efficiency at various speeds.

It is to these perceived needs that the present invention is directed.

### SUMMARY OF THE INVENTION

The present invention relates to a system for regulating lubricant flow in a variable speed compressor comprising a compressor having an inlet for gas to be compressed, a lubricant injection line, and a lubricant outlet through which compressed gas and lubricant exit, a means for observing the operational speed of the compressor, a flow control interface comprising a valve for regulating the flow of lubricant through the lubricant injection line, and a control logic disposed in communication with the means for observing the operational speed of the compressor and the flow control interface wherein the control logic receives a signal from the means for observing the operational speed of the compressor and sends a signal to the flow control interface to regulate flow through the valve in response to the predetermined optimum lubricant flow rate for the compressor based upon the operational speed.

In another embodiment of the present invention, the system further comprises a compressor motor wherein the compressor motor drives the compressor and the operational speed of the compressor is observed through the speed of the compressor motor and the control logic is disposed in communication with the compressor motor and receives the operational speed of the motor driving the compressor. Additionally, the system may further comprise a variable speed drive wherein the variable speed drive controls the compressor motor and operational speed of the compressor is observed through the variable speed drive and the control logic is disposed in communication with the variable speed drive such that the speed of the variable speed drive is communicated to the control logic.

In an embodiment of the present invention, the valve of the system may be a solenoid valve or may comprise two or more valves. The compressor is a rotary screw compressor and more preferably is an oil flooded rotary screw compressor. In further embodiments of the present invention, the control logic may be an integral part of the variable speed drive or may be an integral part of the air compressor.

In a further embodiment of the present invention, the compressor system further comprises a plurality of lubricant injection lines and at least one of the lubricant injection lines is controlled by the flow control interface. Furthermore, the plurality of lubricant injection lines comprise orifices of different sizes.

In a still further embodiment of the present invention, the system further comprises an air-lubricant separator fluidly connected to the compressor outlet, a lubricant cooler, and a lubricant filter wherein the air-lubricant separator, the lubricant cooler, and the lubricant filter are fluidly connected to one another and the compressor through the lubricant injection line.

Yet another embodiment of the present invention provides a system for regulating lubricant flow in a variable speed compressor comprising an oil flooded rotary screw compressor having an inlet for gas to be compressed, an oil injection line, and an outlet through which compressed gas and oil exit, a compressor motor driveably connected to the compressor, a variable speed drive controllably connected to the compressor motor, a flow control interface comprising a solenoid valve for regulating the flow of lubricant through the oil injection line, and a control logic disposed in communication with the variable speed drive and the flow control interface wherein the control logic receives a signal from the variable speed drive indicating the operational speed of the compressor and sends a signal to the flow control interface to regulate flow through the solenoid valve in response to the predetermined optimum lubricant flow rate for the compressor based upon the operational speed.

Another embodiment of the present invention relates to a method for regulating lubricant flow in a variable speed compressor comprising the steps of, measuring the operating speed of the compressor, determining the appropriate flow of lubricant for the operating speed, and opening or closing a valve to adjust the flow of lubricant. In further embodiments of the present invention, the operating speed of the compressor is approximated by observing the speed of a variable speed drive which controls the speed of the compressor motor.

Still further embodiments of the present invention provide a method for regulating lubricant flow within a compressor wherein the lubricant flow is increased as compressor speed decreases. Additionally, the lubricant flow decreases as compressor speed increases. This may be accomplished wherein the valves are adjusted whenever there is a change in the speed of the compressor or wherein the valves are adjusted at predetermined compressor speeds.

Therefore it is a general object of the present invention to provide a novel and improved system and method for controlling the flow of lubricants through a compressor system.

A further general object of the present invention is to provide a novel and improved system and method for electronically regulating the flow of lubricants through a compressor system.

A further general object of the present invention is to provide novel and improved methods and systems for controlling the flow of lubricants through a compressor such that the compressor operates at optimum efficiency.

A further general object of the present invention is to provide novel and improved methods and systems for operating a variable speed compressor at optimum efficiency by adjusting the flow of lubricant through the compressor in response to changes in compressor speed.

Features of a system and method for lubricant flow control in a variable speed compressor of the present invention may be accomplished singularly, or in combination, in one or more of the embodiments of the present invention. As will be appreciated by those of ordinary skill in the art, the present invention has wide utility in a number of applications as illustrated by the variety of features and advantages discussed below.

As will be realized by those of skill in the art, many different embodiments of a system and method for lubricant flow control in a variable speed compressor package according to the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is a schematic of a compressor system in an embodiment of the present invention.

FIG. 2 is a chart showing the performance of a compressor at various output levels for three different lubricant flow rates.

FIG. 3 is a chart showing an optimized oil flow rate pattern for a compressor according to the present invention.

### DETAILED DESCRIPTION

In an embodiment of the present invention a system is provided which monitors the speed of a compressor and changes the lubricant flow rate to the compressor in such a manner as to optimize the efficiency of the compressor.

Throughout this specification, the terms “oil” and “lubricant” are both used to describe compressor lubricating fluids. This lubricating fluid may serve many functions in addition to lubrication, such as sealing and heat transfer. While the lubricant is usually a petroleum based oil, it may also be a synthetic lubricant or a mixture of natural and synthetic lubricating products, such as ester, glycol, silicone based lubricants or water or water based lubricants. When the term “oil” is used, it refers to a petroleum-based lubricant. When the term “lubricant” is used, it refers to the broader class of acceptable lubricants for compressors mentioned above.

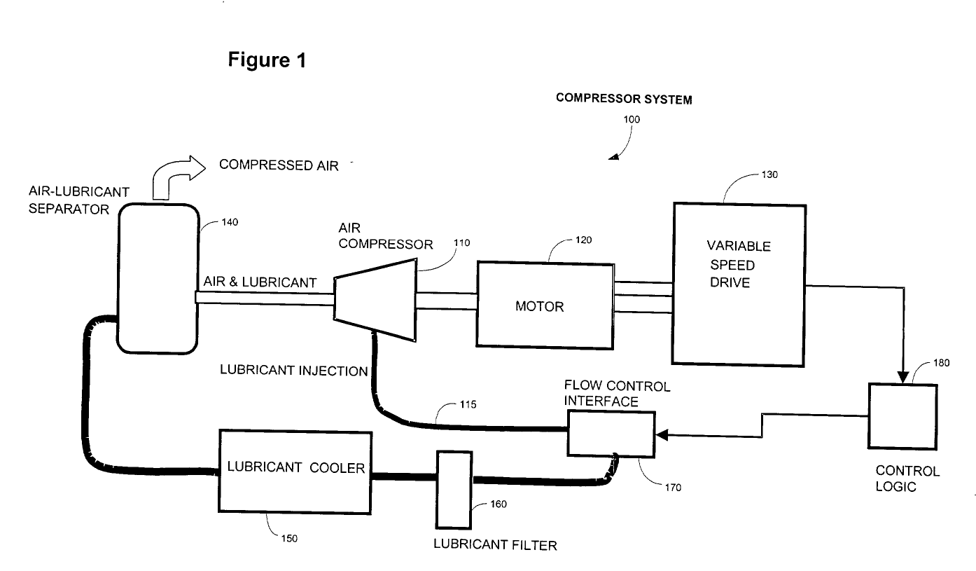

Referring to FIG. 1, in an embodiment of the present invention, a typical compressor system 100 comprises an air compressor 110, driven by a compressor motor 120, which is controlled through a variable speed drive 130. The compressor 110 is fed lubricant through a lubricant injection line 115. After compression, the compressed air/lubricant mixture leaves the compressor 110 and enters the air-lubricant separator 140. In the air-lubricant separator 140 the air is separated from the lubricant and removed for use or storage while the lubricant is fed to a lubricant cooler 150 where the heat generated from the compression of air is removed before the lubricant is sent to a lubricant filter 160 to filter out any remaining particulate impurities or water before re-entering the lubricant injection line 115. The lubricant enters the lubricant injection line 115 at the flow control interface 170. The flow control interface 170 is the point on the lubricant injection line 115 where the lubricant flow is regulated in accordance with the present invention. The lubricant flow rate is determined by a control logic 180 which is in electrical communication with the flow control interface 170. The control logic 180 monitors the speed at which the compressor 110 is operating and sends the appropriate signal to the flow control interface 170 to regulate the lubricant flow for the optimum compressor performance.

In an embodiment of the present invention, the lubricant flow rate is controlled through the interaction of the flow control interface 170 and the control logic 180. The control logic 180 is an automated control that is programmed to respond to inputs relating to compressor speed. The control logic 180 is programmed with the optimum lubricant flow rates for the range of operating speeds of the compressor 110. In a preferred embodiment of the present invention, a sensor in the variable speed drive 130 communicates the speed of the variable speed drive 130, which is directly proportional to the speed of the compressor 110, to the control logic 180. However, the speed of the compressor 110 may be determined through means other than monitoring the variable speed drive 120. In an embodiment of the present invention, the flow rate of gas exiting the compressor 110 is used to approximate the speed of the compressor 110. In a further embodiment of the present invention, the speed of the compressor 110 is measured by observing the speed of the compressor motor 120. Regardless, once the speed of the compressor is determined, this information is passed on to the control logic 180.

The control logic 180 receives the operational speed of the compressor and compares the compressor speed to predetermined compressor speed/lubricant flow rate combinations to determine the optimum lubricant flow rate for the measured compressor speed. The control logic 180 then communicates the desired lubricant flow rate to the flow control interface 170. In one embodiment of the present invention, the control logic 180 sends a signal to the flow control interface 170, which then determines the proper valve positions. In another embodiment of the present invention, the control logic 170 determines the proper valve positions and communicates this information directly to the valves within the flow control interface 170.

The flow control interface 170 is the point along the lubricant injection line 115 where the lubricant flow rate is controlled. In one embodiment of the present invention, the flow control interface comprises a processor which receives the desired flow rate information from the control logic 180, monitors the flow rate through the system and makes the proper adjustments. In another embodiment of the present invention, the flow control interface is in direct communication with the control logic 180 and responds directly to signals from the control logic 180. In a preferred embodiment of the present invention, the flow control interface 170 comprises electrically operated solenoid valves. The flow control interface 170 may lie at any point along the lubricant injection line, including the interface between the injection line 115 and the compressor. In one embodiment of the present invention, the flow control interface 170 is incorporated into the housing of the compressor 110 and forms an integral part thereof

In another embodiment of the present invention, the compressor system employs two or more valves which operate together to regulate the flow of lubricant to the compressor. In one embodiment of the present invention, a series of orifices in the lubricant injection line are controlled with electrically operated valves. As the demand for lubricant is increased, additional valves are opened within the flow control interface 170. In another embodiment of the present invention, the orifices vary in size to allow different flow rates through the different sizes orifices. As the lubricant demands change, the flow rate is adjusted by opening and closing combinations of the different sized orifices such that the optimum flow rate is achieved. In another embodiment of the present invention, the orifices are the same size and are opened in sequence to allow a step-wise adjustment in lubricant flow to the compressor. One skilled in the art will recognize the various size and number combinations of orifices to achieve optimum lubricant flow for given compressor speeds.

In the preferred embodiments of the present invention, electrically controlled valves are used to regulate the flow of lubricant through the compressor system. Any type of valve may be employed as is commonly used in the industry. Suitable valves for use in such an application include gate valves, globe valves, angle valves, diaphragm valves, plug cocks, ball valves butterfly valves, lift check valves, or any other valve as is known in the art.

In a preferred embodiment of the present invention, lubricant flow is regulated through two parallel orifices in the lubricant injection line. One of the orifices remains open at all times allowing a minimum amount of lubricant to flow to the compressor. The other orifice can be opened or closed to regulate the lubricant flow. The size of the orifices will be determined by the lubricant flow rates required by the compressor. This system ensures that at all times at least a minimum amount of lubricant is lubricating the compressor through the first orifice. As the compressor speed changes, the second orifice is opened or closed depending on the predetermined optimum lubricant flow rate for the new operating speed.

In a preferred embodiment of the present invention, the second orifice is capable of being opened or closed by a solenoid valve. When the valve is open and lubricant is flowing through both orifices, maximum lubricant flow is achieved. When the valve is closed and lubricant is only flowing through the first orifice, minimum lubricant flow is achieved. For example, when operating at low compressor speeds, the solenoid valve in the second compressor would be open allowing maximum lubricant flow at the low compressor speed. When the compressor speed exceeded a certain threshold point, the solenoid valve would close and lubricant would only flow through the first orifice, thereby providing a minimum lubricant flow at the high compressor speed.

The compression of gasses is an exothermic process. One function of the lubricating fluid is to cool the compressor by absorbing heat in the compressor and carrying it away. Therefore, the lubricant leaving the compressor will be hotter than the lubricant entering the compressor. For example, the lubricant/air mixture leaving an oil flooded rotary screw compressor can be 190° F. or more and if the oil temperature reaches 235° F., the compressor automatically shuts down before it overheats and sustains damage. In order to maintain safe and efficient operating temperatures inside the compressor, the heat must be removed from the lubricant before the lubricant reenters the compressor. This is accomplished through a lubricant cooler 150 located along the lubricant injection line 115 after the air-lubricant separator 140. In one embodiment of the present invention, the lubricant cooler 150 is a simple heat exchanger that removes heat from the fluid through means known in the art.

Additionally, as the lubricant completes the cycle through the compressor system, it can accumulate contaminates such as dirt and other particulate matter. These contaminates may enter the compressor system along with the incoming gas to be compressed, or may be particulate matter from within the compressor system. This collection of dirt, metal, water and other contaminates can damage the compressor and other component parts and decrease the efficiency of the system. Therefore, it is desirable to filter the lubricant to remove these contaminates so they do not build up inside the compressor and cause damage to the system.

In an embodiment of the present invention, the lubricant filter 160 is fluidly connected to the lubricant injection line 115 between the air-lubricant separator 140 and the compressor. The lubricant filter 160 removes the aforementioned particulate matter from the lubricant stream. Additionally, the lubricant filter 160 may serve to remove moisture that has accumulated in the lubricant stream. In a preferred embodiment the lubricant cooler 150 and lubricant filter 160 are located after the lubricant separator 140 and before the flow control interface 170. The lubricant cooler 150 is positioned before the lubricant filter 160 to optimize removal of moisture in the lubricant stream.

In another embodiment of the present invention, a method for regulating lubricant flow to a variable speed compressor is provided. In an embodiment of the present invention, this method is carried out using the compressor system described herein. In yet another embodiment of the present invention, this method is conducted using a different variable speed compressor configuration. By controlling lubricant flow as the compressor speed changes, the efficiency of the compressor system can be maintained at optimum levels. While lubricant-flooded rotary screw compressors may differ slightly in size, maximum output and design, their efficiency is tied to the general principle that as compressor speed decreases, lubricant flow should increase to achieve greater efficiencies. The precise flow rate of lubricant for the various compressor speeds can be determined by simple testing, as is described in more detail in the examples. Once the optimum flow rates for various compressor speeds are determined, they can be used to optimize the compressor. The speed of the compressor can be determined directly using internal sensors, or indirectly by monitoring the flow rate of gas leaving the compressor or the speed of the motor driving the compressor. Once the compressor speed is determined, it is matched against the predetermined optimum lubricant flow for that speed. The lubricant flow rate is then adjusted to match the optimum lubricant flow for the speed of the compressor.

In one embodiment of the present invention, the lubricant flow is changed continuously as compressor speed changes. In another embodiment of the present invention, the lubricant flow changes only at predetermined intervals. By changing the lubricant flow at predetermined intervals, a system can be designed with few moving parts and less need for adjustment and fine tuning.

Although the present invention has been described with reference to particular embodiments, it should be recognized that these embodiments are merely illustrative of the principles of the present invention. Those of ordinary skill in the art will appreciate that the system and methods of the present invention may be constructed and implemented in other ways and embodiments. Accordingly, the description herein should not be read as limiting the present invention, as other embodiments also fall within the scope of the present invention.

### EXAMPLES

The following three test runs were conducted on a 204 mm oil flooded screw compressor with a length to diameter ratio of 1.23 and a modified SRM C rotor profile. This compressor was chosen merely as an example to illustrate the present invention and by no means is the scope of the present invention limited to this configuration. Three runs were conducted at different oil flow rates. The following curves show how much energy (kilowatts) it takes to deliver 100 cubic feet per minute (CFM) air at different compressor output rates. Since the output of the compressor in CFM is directly proportional to the speed of the compressor, this is a good indication of how efficiently the compressor is running at the various output levels.

Test run at 110 PSIG and 25.5 gpm oil flow

| Compressor speed | Compressor output | Work | Efficiency |
|---|---|---|---|
| (RPM) | (CFM) | (KW) | (KW/100 CFM) |
| 2900 | 458.5 | 93.40 | 20.37 |
| 2700 | 427.3 | 85.87 | 20.09 |
| 2000 | 309.4 | 62.37 | 20.16 |
| 1500 | 228.9 | 47.40 | 20.71 |
| 1000 | 145.7 | 33.00 | 22.65 |
| 600 | 82.2 | 22.80 | 27.74 |

Test run at 110 PSIG and 20 gpm oil flow

| Compressor speed | Compressor output | Work | Efficiency |
|---|---|---|---|
| (RPM) | (CFM) | (KW) | (KW/100 CFM) |
| 2900 | 460.3 | 92.10 | 20.01 |
| 2700 | 428.6 | 85.57 | 19.97 |
| 2000 | 314.9 | 61.60 | 19.56 |
| 1500 | 232 | 47.27 | 20.38 |
| 1000 | 146.1 | 33.03 | 22.61 |
| 600 | 80.8 | 23.20 | 28.70 |

Test run at 110 PSIG and 15 gpm oil flow

| Compressor speed | Compressor output | Work | Efficiency |
|---|---|---|---|
| (RPM) | (CFM) | (KW) | (KW/100 CFM) |
| 2900 | 462.1 | 90.57 | 19.60 |
| 2700 | 430.2 | 84.33 | 19.60 |
| 2000 | 316.9 | 61.92 | 19.54 |
| 1500 | 225.7 | 48.07 | 21.30 |
| 1000 | 147.6 | 34.37 | 23.29 |
| 600 | 83.5 | 25.10 | 30.06 |

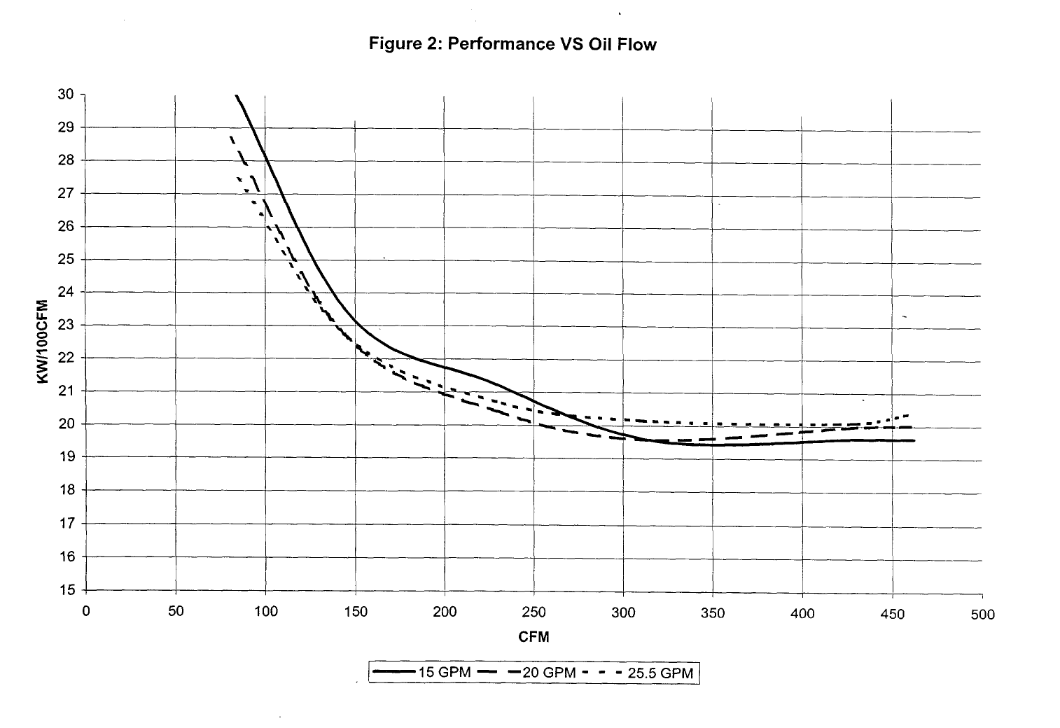

FIG. 2 is a chart of performance, measured in kilowatts per 100 CFM verses compressor output, measured in CFM for the three different oil flows. The solid line represents an oil flow of 15 GPM, the dashed line represents an oil flow of 20 GPM and the dotted line represents an oil flow of 25.5 GPM. The chart clearly illustrates that at lower compressor outputs, in this case ranging from 0 to about 150 CFM an oil flow rate of 25.5 GPM yields the most efficient operating condition indicated by the lowest line on the chart in that region. For the region from about 150 to about 335 CFM an oil flow rate of 20 GPM illustrated by the dashed line being the lowest on the curve, results in the most efficient compressor. For the region of high flow rates, from about 325 GPM+ the compressor operates most efficiently with an oil flow rate of 15 GPM, illustrated by the solid line.

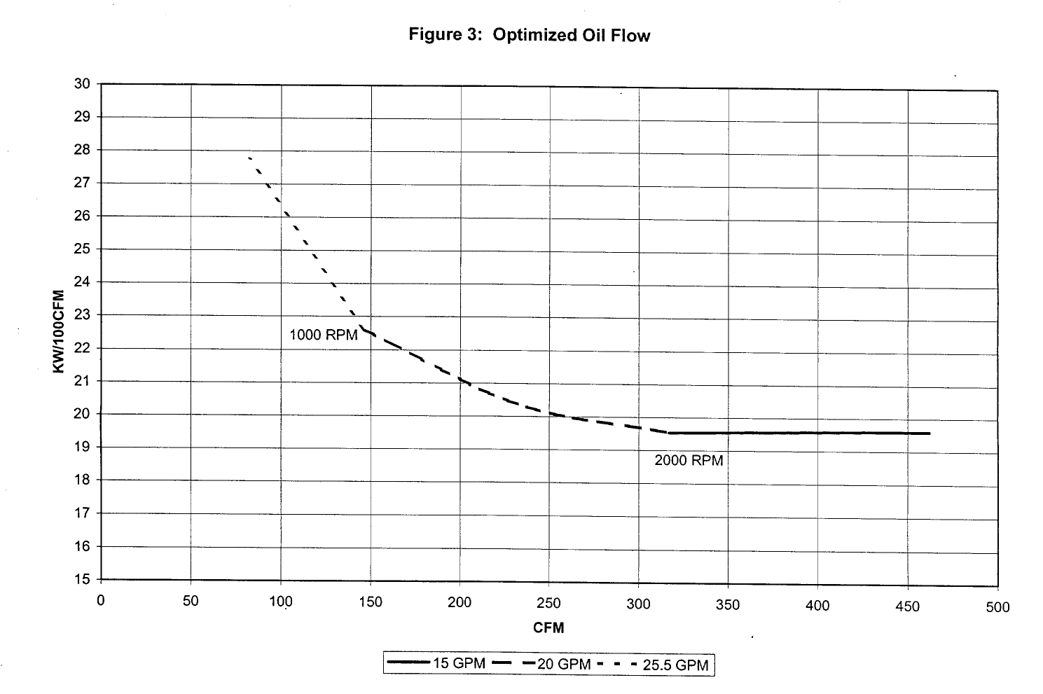

From this figure, it is clear that to optimize the efficiency of a variable compressor operating over a wide range of output rates, would require changes in the oil flow rate. The present invention allows the compressor output to be monitored through the variable speed drive and the oil flow rate to be changed accordingly. This is illustrated in FIG. 3. FIG. 3 show the optimized oil flow for the compressor tested in FIG. 2. One skilled in the art will recognize that this concept may be employed with any variable speed compressor.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A system for regulating lubricant flow in a variable speed compressor comprising:
a compressor having an inlet for gas to be compressed, a lubricant injection line, and an outlet through which compressed gas and lubricant exit;
a means for observing the operational speed of the compressor;
a flow control interface comprising a valve for regulating the flow of lubricant through the lubricant injection line; and,
a control logic disposed in communication with the means for observing the operational speed of the compressor and the flow control interface,
wherein the control logic receives a signal from the means for observing the operational speed of the compressor and sends a signal to the flow control interface to regulate flow through the valve in response to the predetermined optimum lubricant flow rate for the compressor based upon the operational speed.

2. The system of claim 1 further comprising a compressor motor wherein the compressor motor drives the compressor and the operational speed of the compressor is observed through the speed of the compressor motor and the control logic is disposed in communication with the compressor motor and receives the operational speed of the motor driving the compressor.

3. The system of claim 2 further comprising a variable speed drive wherein the variable speed drive controls the compressor motor and operational speed of the compressor is observed through the variable speed drive and the control logic is disposed in communication with the variable speed drive such that the speed of the variable speed drive is communicated to the control logic.

4. The system of claim 1, wherein the valve is a solenoid valve.

5. The system of claim 1 wherein the valve comprises two or more valves.

6. The system of claim 1, wherein the compressor is a rotary screw compressor.

7. The system of claim 1, wherein the compressor is an oil flooded rotary screw compressor.

8. The system of claim 1, wherein the compressor is a water flooded rotary screw compressor.

9. The system of claim 1, wherein the control logic is an integral part of the variable speed drive.

10. The system of claim 1, wherein the flow control interface is an integral part of the air compressor.

11. The system of claim 1, wherein the compressor system further comprises a plurality of lubricant injection lines and at least one of the lubricant injection lines is controlled by the flow control interface.

12. The system of claim 11 wherein the plurality of lubricant injection lines comprise orifices of different sizes.

13. The system of claim 1 further comprising:
an air-lubricant separator fluidly connected to the compressor outlet;
a lubricant cooler;
a lubricant filter;
wherein the air-lubricant separator, the lubricant cooler, and the lubricant filter are fluidly connected to one another and the compressor through the lubricant injection line.

14. A system for regulating lubricant flow in a variable speed compressor comprising:
an oil flooded rotary screw compressor having an inlet for gas to be compressed, an oil injection line, and an outlet through which compressed gas and oil exit;
a compressor motor driveably connected to the compressor;
a variable speed drive controllably connected to the compressor motor;
a flow control interface comprising a solenoid valve for regulating the flow of lubricant through the oil injection line; and,
a control logic disposed in communication with the variable speed drive and the flow control interface,
wherein the control logic receives a signal from the variable speed drive indicating the operational speed of the compressor and sends a signal to the flow control interface to regulate flow through the solenoid valve in response to the predetermined optimum lubricant flow rate for the compressor based upon the operational speed.

15. A method for regulating lubricant flow in a variable speed compressor comprising the steps of:
measuring the operating speed of the compressor;
determining the appropriate flow of lubricant for the operating speed; and
opening or closing a valve to adjust the flow of lubricant.

16. The method of claim 15, wherein the operating speed of the compressor is approximated by observing the speed of a variable speed drive which controls the speed of the compressor motor.

17. The method of claim 15, wherein the lubricant flow is increased as compressor speed decreases.

18. The method of claim 15, wherein the lubricant flow decreases as compressor speed increases.

19. The method of claim 15, wherein the valves are adjusted whenever there is a change in the speed of the compressor.

20. The method of claim 15, wherein the valves are adjusted at predetermined compressor speeds.

21. The method of claim 15, wherein the lubricant is oil.

22. The method of claim 15, wherein the lubricant is water.
